(19) United States
(12) Patent Application Publication
(10) Pub. No.: US 2011/0317708 A1
(43) Pub. Date: Dec. 29, 2011

(54) QUALITY OF SERVICE CONTROL FOR MPLS USER ACCESS

(75) Inventor: John D. CLARK, Northridge, CA (US)

(73) Assignee: Alcatel-Lucent USA, Inc., Murray Hill, NJ (US)

(21) Appl. No.: 12/824,515

(22) Filed: Jun. 28, 2010

(51) Int. Cl. H04L 12/56

(52) U.S. Cl. 370/395.1

(57) ABSTRACT

A method of associating a Quality of Service priority with a Service Access Point (SAP) is disclosed. The method provides for provision of Quality of Service priorities on incoming data packets as per the configuration specified in the SAP associated with the data packet. The method allows for a configuration in which the incoming packet will specify its own QoS priority. The provisioning of Quality of service on a per SAP basis allows for a finer granularity of prioritizing of packets over Quality of Service methods known in the art.

### FIELD OF THE INVENTION

The invention relates to priority treatment of data packets and is particularly concerned with Quality of Service treatments of data packets within a Virtual Private LAN Service (VPLS) arriving at an ingress switch.

### BACKGROUND OF THE INVENTION

The traffic engineering resource reservation control mechanism referred to as Quality of Service (QoS) refers to the ability to reliably provide different grades of service to different users, data flows, or applications under varying degrees of network loading. The grades of service may be specified by a variety of parameters, for example, maximum jitter, packet arrival order, packet dropping probability, required bit rate, bit error rate, or delay, among others.

Historically, the Internet has evolved from a best-effort network wherein “Type of Service” and “Precedence” bits located in packet headers were not utilized, through ATM and Frame Relay layer 2 technologies which added QoS tags to the data.

Current QoS solutions rely on per port solutions which may be too generalized. Referring to FIG. 1 there may be seen a network edge router 112 connected to Customer Equipment CE 1 102 at port 110a, and CE 2 104 at port 110b and CE 3 106 at port 110c. Within network edge router 112 are modules providing VPLS services 116, and Service Distribution Point (SDP) services 114, to connect through VPLS tunnel 120 into the MPLS network 130. Each CE entity is assigned a specific QoS, and packets arriving at the respective ports will be assigned that QoS.

Alternatively, current QoS solutions are based on conditions related to classification of user data. Examples of conditions include but are not limited to IP networks, MAC address ranges, 802.1Q VLANs, etc. Referring to FIG. 2 there may be seen a network edge router 212 connected to Customer Equipment CE 1 202 at port 210, and CE 2 206 also at port 210. Within network edge router 212 are modules providing VPLS services 216, and Service Distribution Point (SDP) services 214, to connect through VPLS tunnel 220 into the MPLS network 230. CE 1 202 is assigned a specific QoS based upon it comprising an 802.1Q VLAN, whereas CE 2 206 is assigned a specific QoS based upon it having an IP Net address of 192.168.0.0 by way of example, and packets arriving from the respective CEs will be differentiated and assigned their QoS on that basis.

These QoS solutions are still at a high level of granularity and are not well suited to VPLS (Virtual Private LAN Service) environments where network layer 3 conditions may be unknown or irrelevant. Even the ability to classify on network layer 2 conditions is constrained to be less than optimal since a single access port may be tied to multiple VPLS services for which an operator desires different QoS priorities to be assigned.

Multiprotocol Label Switching (MPLS) is a protocol which links and carries data between network nodes by encapsulating packets. Under this protocol, data packets are assigned labels and packet-forwarding decisions are made on the contents of the label without determination of the data contents of the packet. MPLS supports a range of access technologies and protocols, including DSL, Frame Relay, T1 and ATM and provides traffic management benefits which are yielding a continuing increasing use of this protocol.

The MPLS protocol has been described as a Network Layer 2.5 protocol, existing between Network Layers 2 and 3. For subscribers connecting to an MPLS network over a VPLS, it would be desirable to have a Quality of Service (QoS) solution on a per subscription basis for data accessing a VPLS in an MPLS environment.

### SUMMARY OF THE INVENTION

It is an object of the invention to provide a means of providing a QoS solution on a per subscription basis for data accessing a VPLS in an MPLS environment.

According to an aspect of the invention there is provided a method for assigning a Quality of Service metric to a data packet arriving at a port on an ingress switch for use in a VPLS network, the method comprising the steps of configuring a Service Access Point for a VLAN service; determining for the data packet whether it is associated with the VLAN service; and applying a Quality of Service metric as configured for the Service Access Point in the event that the data packet is associated with the VLAN service.

In another embodiment of the invention, there are further steps of associating a trusted status to the Service Access Point. In this embodiment, there may also be the additional step of applying an internal priority to the packet. In certain embodiments the internal priority may be derived from an 802.1Q priority tag within a header of the packet. In other versions of this embodiment the internal priority may be derived from a default port priority associated with the port.

In another embodiment of the invention, there may be the steps of associating an untrusted status to the Service Access Point. In this embodiment, there may also be the additional step of applying an internal priority to the packet. In certain versions of this embodiment the internal priority is assigned at the configuring step.

In yet another embodiment of the invention, there may be the steps of defining an internal priority for those packets which do not have a defined SAP, and associating the internal priority to the arriving data packet in the event the arriving packet is not associated with a Service Access Point on the port.

According to another aspect of the invention there is provided an apparatus for assigning a Quality of Service metric to a data packet arriving at a port on an ingress switch for use in a VPLS network, the apparatus having a processor for executing instructions; a memory device having thereon modules of operational data and executable code for execution by the processor, the operational and executable data comprising instructions for configuring a Service Access Point for a VLAN service; determining for the data packet whether it is associated with the VLAN service; and applying a Quality of Service metric as configured for the Service Access Point in the event that the data packet is associated with the VLAN service.

In another embodiment of the invention, there is a trusted status associated to the Service Access Point. In this embodiment there may also be an internal priority applied to the packet. In some versions of this embodiment the internal priority is derived from an 802.1Q priority tag with a header of the packet. In other versions of this embodiment the internal priority is derived from a default port priority associated with the port.

In another embodiment of the invention, there is an untrusted status associated to the Service Access Point. In this embodiment, there may also be the additional step of applying an internal priority to the packet. In certain versions of this embodiment the internal priority is assigned at the configuring step.

In yet another embodiment of the invention, there is an internal priority defined for those packets which do not have a defined SAP, and the internal priority is associated to the arriving data packet in the event the arriving packet is not associated with a Service Access Point on the port.

Note: in the following the description and drawings that follow merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

### BRIEF DESCRIPTION OF THE DRAWINGS

The present invention will be further understood from the following detailed description of embodiments of the invention, with reference to the drawings in which:

FIG. 1 illustrates a block diagram of a system according to the prior art wherein multiple pieces of Customer Equipment have varying QoS levels assigned per port;

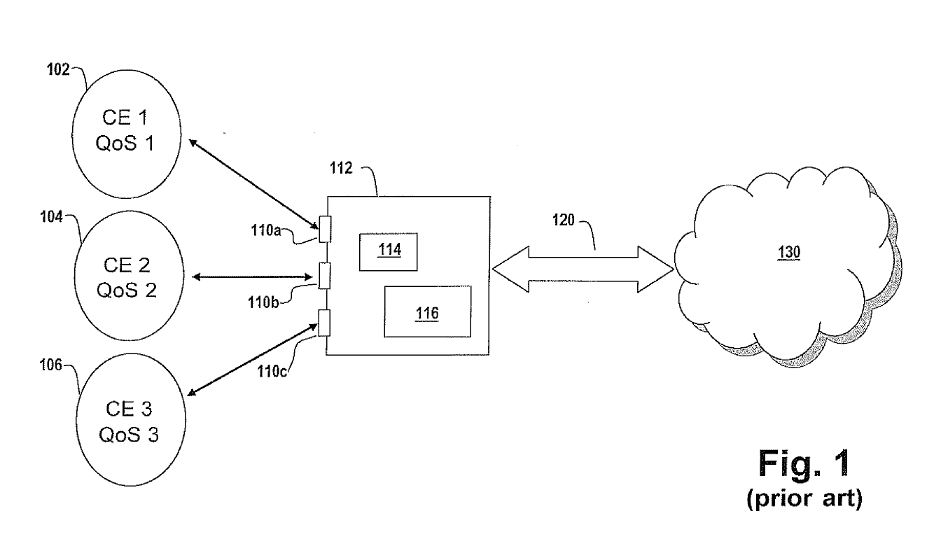

FIG. 2 illustrates a block diagram of a system according to the prior art wherein a single access port uses Layer 3 and Layer 2 conditions for application of QoS priorities; and

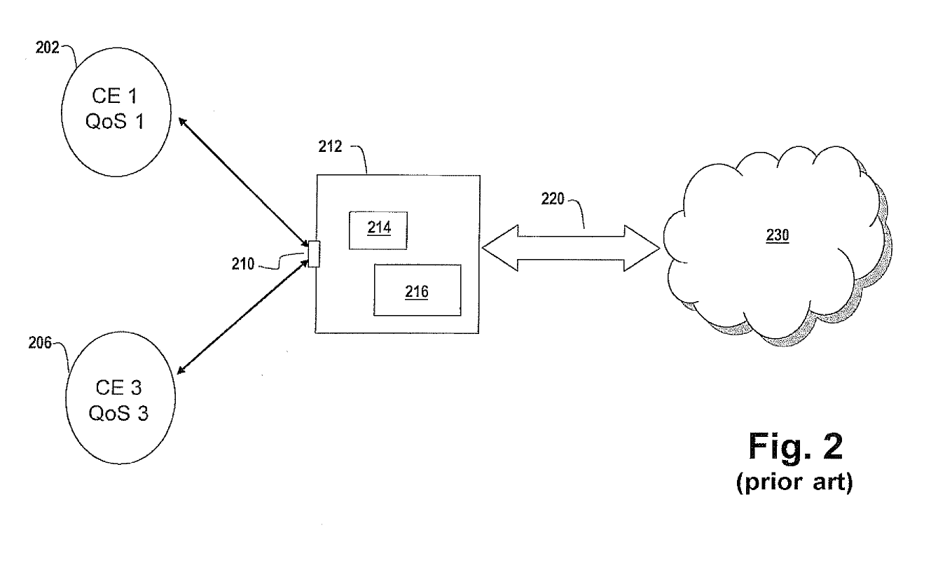

FIG. 3 illustrates a block diagram of a system in accordance with an embodiment of the present invention.

In the following figures, like features bear similar reference labels.

### DETAILED DESCRIPTION

In the service model for an embodiment of the present invention, service edge routers are deployed at the provider edge.

Services, which are globally unique entities that refer to a type of connectivity service for either Internet or VPN connectivity, are provisioned on the service routers and transported across an IP and/or IP/MPLS provider core network in encapsulation tunnels created using MPLS label switched paths (LSPs). In terms of individual MPLS VPLS there is provided a way of setting priorities within a Forwarding Equivalency Class (FEC).

The service model uses logical service entities to construct a service. The logical service entities are designed to provide a uniform, service-centric configuration, management, and billing model for service provisioning. Some benefits of this service-centric design include:
Many services can be bound to a single customer.
QoS policies, filter policies, and accounting policies are applied to each service instead of correlating parameters and statistics from ports to customers to services.

Service provisioning uses logical entities to provision a service where additional properties can be configured for bandwidth provisioning, QoS, security filtering, accounting/billing to the appropriate entity. One such logical entity is the Service Access Point which serves as the customer access to the MPLS. Another such logical entity is the Service Distribution Point which relates to the other routers the service is associated with, and describes the transport tunnel encapsulation, such as MPLS/RSVP-TE, MPLS-LDP, or IP-GRE, that the service uses.

Each subscriber service type is configured with at least one service access point (SAP). A SAP identifies the customer interface point for a service on an edge router.

A SAP is a local entity to the router and is uniquely identified by:
The physical Ethernet port
The encapsulation type
The encapsulation identifier (ID)

Depending on the encapsulation, a physical port can have more than one SAP associated with it. SAPs are only created on ports designated as “access” in the physical port configuration of an edge router.

Common to SAPs are policies that are assigned to the service. Examples of policies include filter policies, scheduler policies, and accounting policies.

Filter policies allow selective blocking of traffic matching criteria from ingressing or egressing a SAP. Filter policies, also referred to as access control lists (ACLS), control the traffic allowed in or out of a SAP based on MAC or IP match criteria. Associating a filter policy on a SAP is optional. Filter policies may identified by a unique filter policy ID. In use a single ingress and single egress filter policy is associated with a SAP.

Scheduler policies define the operating parameters (such as scheduling algorithm, weights per priority). They are associated with physical ports of the router.

Accounting policies define how to count the traffic usage for a service for billing purposes.

In normal use, the routers provide a comprehensive set of service-related counters. Accounting data can be collected on a per-service, per-forwarding class basis, which enables network operators to accurately measure network usage and bill each customer for each individual service using any of a number of different billing models.

In an exemplary system a specific SAP could describe:
an 802.1Q Virtual Local Area Network (VLAN) entering the VPLS; or
a collection of 802.1Q VLANs; or
untagged packets arriving at the physical port.

According to a proposed embodiment of the invention there is provided a feature called “Trusted/Untrusted” within the Service Access Point configuration.

In this embodiment a SAP may be configured to be Trusted or Untrusted.

If a SAP is configured to be Trusted, then Internal QoS Priority for ingress packet traffic on that SAP is derived:
from the 802.1Q tagged packet Priority of the ingress packet; or
from a Default Port Priority, if the ingress packet is not tagged.

If a SAP is Untrusted then Internal QoS Priority for ingress packet traffic on that SAP is derived from a priority specified by the operator when the SAP is configured.

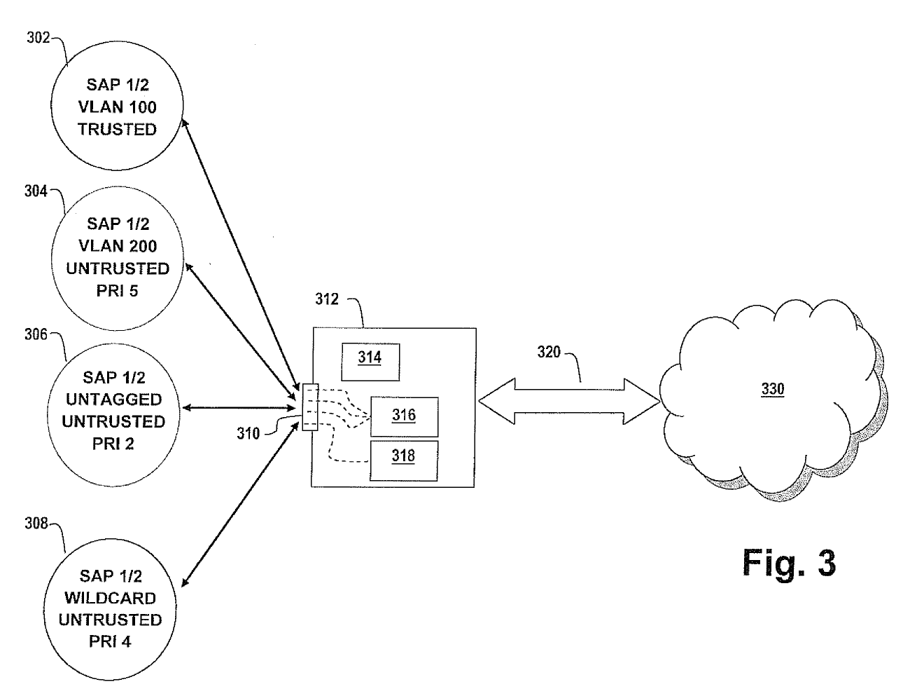

Referring now to FIG. 3 there may be seen a network edge router 312 having a port 310 connected to Customer Equipment CE 1 302 which is tagged as a VLAN service, for this example VLAN 100; CE 2 304 which is also tagged as a VLAN service but for this example VLAN 200; CE 3 306 which is an untagged packet stream; and CE 4 308 which is a wildcard SAP. Within network edge router 312 are modules providing VPLS services 316 and 318, and Service Distribution Point (SDP) services 314, to connect through VPLS tunnel 320 into the MPLS network 330. CE 1 302 is configured as Trusted in its associated SAP, and CE 2 304, CE 3 306, and CE 4 308 are configured as Untrusted in their respective SAPs.

According to the operation of the invention in this embodiment, CE 1 302 is considered tagged and Trusted. When a packet arrives, whatever PRI is carried in the 802.1Q priority header tag will be used for this packet stream. These packets will be processed by VPLS service 316 with the determined QoS priority. Note that conditions and actions can still be created for Layer 2 and Layer 3 QoS, but this PRI simply overlays the 802.1Q packet stream in general by using the specific PRI header tag because of the Trusted configuration.

According to the operation of the invention in this embodiment, CE 2 304 is considered tagged and Untrusted and the operator has assigned a PRI of 5 to the packets. These packets will be processed by VPLS service 316 with the determined QoS priority. Note that conditions and actions can still be created for Layer 2 and Layer 3 QoS, but that this PRI simply overlays the 802.1Q packet stream in general.

According to the operation of the invention in this embodiment, CE 3 306 is considered untagged and Untrusted. For such packets the operator has assigned a PRI of 2 to the packets. These packets will be processed by VPLS service 316 with the determined QoS priority. Note that conditions and actions can still be created for Layer 2 and Layer 3 QoS, but that this PRI simply overlays the 802.1Q packet stream in general.

According to the operation of the invention in this embodiment, CE 4 308 is considered a Wildcard SAP and Untrusted. The Wildcard SAP is special and has the characteristic of taking any remaining traffic not specified for the other SAPs on the port. Hence all remaining 802.1Q VLANs will receive an operator assigned PRI of 4 and will be processed by VPLS service 318 with the determined QoS priority. Note that conditions and actions can still be created for Layer 2 and Layer 3 QoS, but this PRI simply overlays the 802.1Q packet stream in general.

In the example of FIG. 3, the SAPs have each been configured on a single port for both services. Multiple SAPs could be added for the different ports of the edge router yielding a many-to-many configuration. In practice, the number of available combinations is very large. Each port may have 4097 SAPs and each service could be bound to every port where the maximum number of SAPs existed per port. The important distinguishing aspect here is that each SAP may have a unique QoS Priority in addition to other QoS rules created by normal QoS conditions and actions for the physical port and edge router as a whole.

In summary, an apparatus and associated method has been disclosed which provides a QoS to be assigned at a Service Access Point. The apparatus and method allow for the QoS to be specifically assigned for the unique service to which the incoming packet is associated, and further allows for the packet to specify its own QoS priority if so configured at the corresponding SAP. The disclosed apparatus allows operation which provides finer granularity of QoS control for user data entering VPLS network edge devices.

It is to be understood that various changes in the details, materials, and arrangements of the parts which have been described and illustrated in order to explain the nature of this invention may be made by those skilled in the art without departing from the scope of the invention as expressed in the following claims.

It should also be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.” Numerous modifications, variations and adaptations may be made to the embodiment of the invention described above without departing from the scope of the invention, which is defined in the claims.

What is claimed is:

1. A method for assigning a Quality of Service metric to a data packet arriving at a port on an ingress switch for use in a VPLS network, the method comprising the steps of:
configuring a Service Access Point for a VLAN service;
determining for said data packet whether it is associated with said VLAN service; and
applying a Quality of Service metric as configured for said Service Access Point in the event that said data packet is associated with said VLAN service.

2. A method as claimed in claim 1, wherein said configuring step comprises
associating a trusted status to said Service Access Point.

3. A method as claimed in claim 2, wherein said applying step comprises
applying an internal priority to said packet.

4. A method as claimed in claim 3, wherein said internal priority is derived from an 802.1Q priority tag within a header of said packet.

5. A method as claimed in claim 3, wherein said internal priority is derived from a default port priority associated with said port.

6. A method as claimed in claim 1, wherein said configuring step comprises:
associating an untrusted status to said VLAN service.

7. A method as claimed in claim 6, wherein said applying step comprises
applying an internal priority to said packet.

8. A method as claimed in claim 7, wherein said internal priority is derived from a priority assigned at said configuring step.

9. A method as claimed in claim 1, further comprising the steps of:
defining an internal priority for those packets which do not have a defined SAP, and
associating said internal priority to said arriving data packet in the event said arriving packet is not associated with a Service Access Point on said port.

10. An apparatus for assigning a Quality of Service metric to a data packet arriving at a port on an ingress switch for use in a VPLS network, the apparatus comprising:
a processor for executing instructions;
a memory device having thereon modules of operational data and executable code for execution by said processor, the operational and executable data comprising instructions for:
configuring a Service Access Point for a VLAN service;
determining for said data packet whether it is associated with said VLAN service; and
applying a Quality of Service metric as configured for said Service Access Point in the event that said data packet is associated with said VLAN service.

11. An apparatus as claimed in claim 10, further comprising
a trusted status associated to said Service Access Point.

12. An apparatus as claimed in claim 11, further comprising
an internal priority applied to said packet.

13. An apparatus as claimed in claim 12, wherein said internal priority is derived from an 802.1Q priority tag within a header of said packet.

14. An apparatus as claimed in claim 12, wherein said internal priority is derived from a default port priority associated with said port.

15. An apparatus as claimed in claim 10, further comprising
an untrusted status associated to said VLAN service.

16. An apparatus as claimed in claim 15, further comprising
an internal priority applied to said packet.

17. An apparatus as claimed in claim 16, wherein said internal priority is derived from a priority assigned at said configuring step.

18. An apparatus as claimed in claim 10, further comprising:
an internal priority defined for those packets which do not have a defined SAP, and
said internal priority associated to said arriving data packet in the event said arriving packet is not associated with a Service Access Point on said port.
